(19) United States
(12) Patent Application Publication
(10) Pub. No.: US 2025/0360801 A1
(43) Pub. Date: Nov. 27, 2025

(54) METHOD FOR BRAKING A VEHICLE HAVING TWO ELECTRIC DRIVE MOTORS, A COMPUTING UNIT, AND A COMPUTER PROGRAM

(71) Applicant: Robert Bosch GmbH, Stuttgart (DE)

(72) Inventors: Harald Giuliani, Wien (AT); Joachim Sick, Wiefelstede (DE); Thomas Friedrich, Ingersheim (DE)

(21) Appl. No.: 18/998,616

(22) PCT Filed: Jul. 24, 2023
(86) PCT No.: PCT/EP2023/070461

§ 371 Date: Jan. 27, 2025

(30) Foreign Application Priority Data
Jul. 27, 2022 (DE) 10 2022 207 691.5

(51) Int. Cl. B60L 15/20

(52) U.S. Cl. CPC B60L 15/2009; B60L 2220/42; B60L 2240/12; B60L 2240/423

(57) ABSTRACT

The invention relates to a method for braking a vehicle (10) having a first (14) and a second (16) electric drive motor, wherein, in a first braking phase, a first target value for a braking torque is specified to the first electric drive motor (14), and a second target value for a braking torque is specified to the second electric drive motor (16), wherein a current speed of the vehicle (10) is sensed as the actual speed, wherein, when the actual speed reaches a first threshold value (v₀) for a vehicle speed, the first target value for a braking torque is increased in a redistribution phase and the second target value for a braking torque is simultaneously reduced, wherein, when the actual speed reaches a second threshold value (v₁) for a vehicle speed, the specification of the first target value for a braking torque is ended and a speed target value trajectory (202) is specified in a second braking phase, wherein the speed target trajectory proceeds from the second threshold value (v₁) for the vehicle speed to a speed of zero.

### BACKGROUND

The present invention relates to a method for braking a vehicle with two electric drive motors, as well as a computing unit and a computer program for carrying it out.

Various technical devices are available for braking a vehicle, for example, wheel brakes or electric motors, which are either generator operated so that a braking magnetic field is induced in the coil of the electric motor, or which are selectively energized so that the electric motor is exposed to a torque that slows the vehicle.

Control of electric motors in vehicles is typically based on a target torque as a guide variable. As electric motors can provide both a positive and negative torque regardless of the direction of rotation, in the low speed range, there is the problem of accurately setting a particular position or speed of the electric motor. In this case, it must be ensured that at no time is a torque generated that accelerates the vehicle opposite to a desired direction of movement. If, for example, it is desired that the vehicle decelerate to a stop by means of the electric motor, it must be ensured that no reverse travel initiated by a corresponding torque of the electric motor occurs directly after the stop.

The stopped state of the vehicle is typically detected based on an evaluation of the vehicle speed; the vehicle speed, in turn, is derived from a wheel speed. Incremental encoders are typically used for this purpose, so that the speed signal of the vehicle is only present as a volatile function. Due to this measurement inaccuracy and the fact that latencies are present in the signal processing, the wheel speed is not suitable for use as an input variable for controlling the speed of the vehicle in low speed ranges, in particular at speeds close to zero.

To improve this, DE 10 2019 205 180 A1 presents a method for braking a vehicle comprising an electric drive motor, wherein the vehicle is brought to a standstill using a speed control of the electric drive motor.

### SUMMARY

According to the invention, a method for braking a vehicle using two electric drive motor is proposed, as well as a computing unit and a computer program for carrying it out with the features of the disclosure.

The invention is advantageously suitable for vehicles with a plurality of electric drive motors or a plurality of driven axles, e.g., four-wheel drive (AWD, all-wheel drive), in particular vehicles that support all-electric driving and in which a speed-controlled stop/start operation is possible. With the invention, in particular in a vehicle with a plurality of electrically driven axles, a smooth, comfortable, smooth stopping operation can be ensured, free from fluctuations in deceleration and with a silent stopping process.

The invention therefore makes use of the measure that, even if two or more electric drive motors are used for control operation in a vehicle, the stopping operation which brings the vehicle to a standstill is only achieved via an electric drive machine.

The invention relates in detail to a method for braking a vehicle having a first and a second electric drive motor, wherein, in a first braking phase, a first target value for a braking torque is provided to the first electric drive motor and a second target value for a braking torque is provided to the second electric drive motor, wherein a current speed of the vehicle is sensed as the actual speed, wherein, when the actual speed reaches a first threshold value for a vehicle speed, the first target value for a braking torque is increased in a redistribution phase and the second target value for a braking torque is simultaneously reduced, wherein, when the actual speed reaches a second threshold value for a vehicle speed, the specification of the first target value for a braking torque is ended and a speed target value trajectory is specified in a second braking phase, wherein the speed target trajectory proceeds from the second threshold vehicle speed to a speed of zero.

In other words, when stopping, the entire braking torque is first combined in an electric drive motor in a redistribution phase, which is then also used solely for braking. In particular, in the redistribution phase, the total braking torque remains constant to avoid irritation for the driver. The redistribution phase is in particular terminated so that it is completed promptly by the time the second braking phase begins with specification of the speed target trajectory.

It has been shown that the simultaneous use of both drive motors in speed controlled operation, as is advantageous for a stopping operation, is disadvantageous. Due to the fact that there is a certain scatter in the transmissions (reduction stages, differential) of the drive motors and tires (different sizes, different wear), different wheel speeds occur between the wheels driven by the drive motors (e.g., front and rear wheels). The speed control (or position control) of both drive motors used for stopping may then lead to tension and noises in the chassis, as well as possibly vibrations, due to different wheel speeds.

In the context of the invention, only one electric drive motor is now used for stopping, so that corresponding known methods such as described in the introduction can in particular be used for this purpose.

In one embodiment, in the redistribution phase, the first target value for a braking torque is increased to a sum of the first target value and the second target value at the start of the redistribution phase, and the second target value for a braking torque is reduced to zero. This is advantageous for switching one of the drive motors to inactive. It may then be operated in an idle state.

In one embodiment, the first vehicle speed threshold is determined from an amount of time required to increase the first braking torque target value to a sum of the first target value and the second target value at the start of the redistribution phase and reduce the second braking torque target value to zero. In this embodiment, a shortest possible redistribution phase is assumed, wherein the first threshold value defines the start of the redistribution phase.

In one embodiment, the first threshold for vehicle speed is determined from a current deceleration of the vehicle. This is advantageous because the first threshold value (i.e. the start speed of the redistribution) increases the higher the current deceleration is, so that the redistribution is ended no later than when the second threshold value (i.e. start time of the standstill regulation) is reached.

In one embodiment, the first vehicle speed threshold is determined from the second vehicle speed threshold. This is advantageous so that the redistribution is ended no later than when the second threshold value is reached (i.e., start time of the standstill regulation).

In one embodiment, the first vehicle speed threshold is determined as the sum of the second vehicle speed threshold and a product of the current vehicle deceleration and the amount of time required to increase the first braking torque target value to a sum of the first target value and the second target value at the start of the redistribution phase, and reduce the second braking torque target value to zero. With this solution, the redistribution phase is made as short as possible and can be carried out at the latest possible point in time before the second braking phase.

A computing unit according to the invention, e.g., a control device of a vehicle, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

Further advantages and embodiments of the invention will emerge from the description and the accompanying drawing.

The invention is illustrated schematically in the drawing on the basis of exemplary embodiments and is described in the following with reference to said drawing.

### BRIEF DESCRIPTION OF THE DRAWINGS

FIG. 1 shows a schematic diagram of a vehicle configured to perform an exemplary embodiment of the method according to the invention;

FIG. 2 shows a progression of a speed in an exemplary stopping operation according to a configuration of the invention.

### DETAILED DESCRIPTION

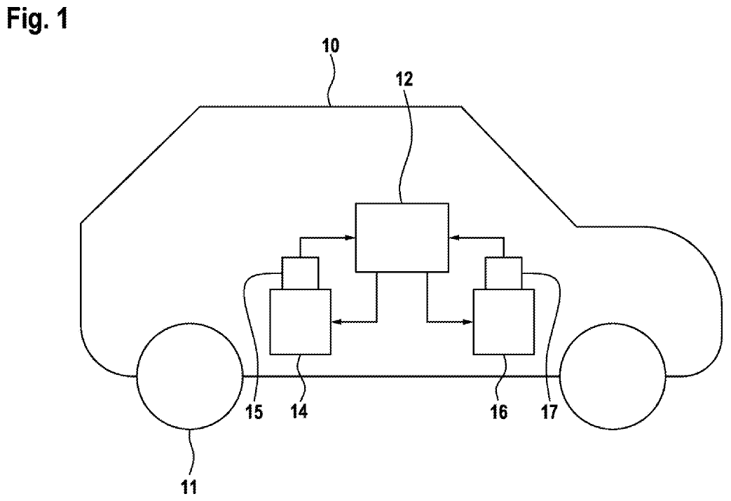

FIG. 1 shows a schematic diagram of a vehicle 10 configured to perform an exemplary embodiment of the method according to the invention. The vehicle 10 comprises a controller 12, which may in particular be the control unit of a power electronics. The vehicle 10 further comprises a first electric drive motor 14 configured to drive at least one wheel 11 of the vehicle 10, for example a rear wheel or the rear axle. A sensor device 15 is disposed on the first electric drive motor 14 such that the sensor device 15 senses and/or transmits an angular position and/or a speed of the first electric drive motor 14 to the controller 12.

The vehicle 10 further comprises a second electric drive motor 16 configured to drive at least one (other) wheel of the vehicle 10, such as a front wheel or the front axle. A sensor device 17 is disposed on the second electric drive motor 16 such that the sensor device 17 senses and transmits an angular position and/or a speed of the second electric drive motor 16 to the controller 12.

The controller 12 is in communication with the first electric drive motor 14 and the second electric drive motor 16 via a signal line so that the electric drive motors 14 and 16, respectively, can be regulated and/or controlled by the controller 12.

For example, if a driver wants to bring the vehicle to a standstill, he or she will typically apply a brake. In the context of one embodiment, it is contemplated that the braking operation may be performed initially using the first drive motor 14 and second drive motor 16, and finally only utilizing the first drive motor 14, as will be described below by way of example, with reference to the figures, contiguously and comprehensively.

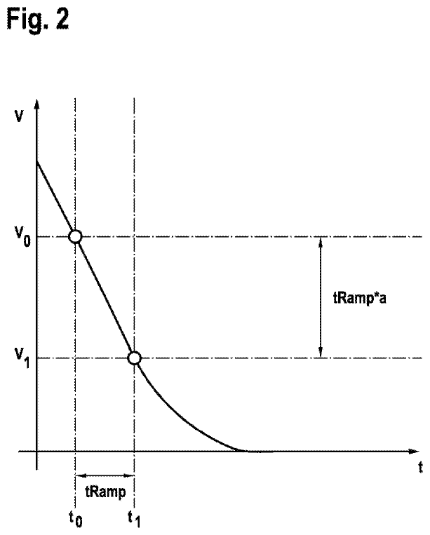

FIG. 2 shows an exemplary stopping operation in the form of a graph in which a vehicle speed v is plotted in relation to time t. Deceleration is carried out in a first braking phase up to time t₀ using the first drive motor 14 and the second drive motor 16, for example by actuating the first drive motor 14 and the second drive motor 16 with a target value for a constant, in particular the same, braking torque. Thus, in this first braking phase, a first target value for a braking torque is provided to the first electric drive motor 14 and a second target value for a braking torque is provided to the second electric drive motor 16.

At the time t₀, the speed v₀ is reached as the first threshold value for a vehicle speed, which represents the trigger event for transitioning to a redistribution phase.

In the redistribution phase, the first target value for a braking torque is increased while the second target value for a braking torque is reduced. In particular, in the redistribution phase, the first target value for a braking torque is increased to a sum of the first target value and the second target value at the start of the redistribution phase, and the second target value for a braking torque is reduced to zero, and the sum of the first and second target value remains constant. The braking operation is thus continued unchanged for the driver, wherein the braking torque is concentrated on the first drive motor. For example, braking may be carried out with a constant deceleration, for example a.

At time t₁ the speed v₁ is reached as the second threshold value for a vehicle speed, which represents the triggering event for the transition to the second braking phase. At this time, a speed target trajectory (in particular, as v(t)) is determined and then the first drive motor 14 is decelerated to a standstill in accordance with this speed target trajectory. The second drive motor 16 is operated in an idle state.

In particular, the speed target trajectory may result in a decrease in the deceleration from the current value a to the value zero at a speed of zero. The decrease in the deceleration can be linear, i.e. a jerk is constant.

A method for calculating the redistribution phase or the first threshold value v₀ for a vehicle speed is described below.

The starting point can be the current deceleration, which is specified by the current braking torque and thus remains unchanged during the redistribution phase according to the above embodiment, meaning it still prevails at the end of the redistribution phase. For this current deceleration or the braking torque associated therewith, an amount of time tRamp is known to be required to increase the first target value for a braking torque to a sum of the first target value and the second target value at the start of the redistribution phase and to reduce the second target value for a braking torque to zero, i.e., a time period for the redistribution. For example, it can be determined in advance in test bench measurements and stored in a characteristic diagram or the like.

From this time period tRamp and the current deceleration a, the speed decrease during the redistribution can be determined as: tRamp*a, and the forecasted speed at the end of the redistribution can be determined as if it were started at the present time with v, as: v−abs (tRamp*a).

The second threshold value v₁ for the vehicle speed results, for example, from the request to decelerate from the speed v−abs (tRamp*a) and the deceleration a with constant jerk to brake to a deceleration of zero and speed of zero. The jerk defines how hard or soft stopping feels for the driver. Thus, it is possible to thereby calculate the entry point of the speed control sequence. A suitable jerk value can, for example, still be selected with respect to comfort or safety aspects.

The first threshold value v₀ for the vehicle speed then results from this as: v₀=v₁+abs (tRamp*a).

1. A method of braking a vehicle (10) having a first (14) and a second (16) electric drive motor,
wherein, in a first braking phase, a first target value for a braking torque is specified for the first electric drive motor (14), and a second target value for a braking torque is specified for the second electric drive motor (16),
wherein a current speed of the vehicle (10) is sensed as the actual speed, wherein, when the actual speed reaches a first threshold value (v₀) for a vehicle speed, the first target value for a braking torque is increased in a redistribution phase and the second target value for a braking torque is simultaneously reduced,
wherein, when the actual speed reaches a second threshold value (v₁) for a vehicle speed, the specification of the first target value for a braking torque is ended and a speed target trajectory (202) is specified in a second braking phase, wherein the speed target trajectory proceeds from the second threshold value (v₁) for the vehicle speed to a speed of zero.

2. The method according to claim 1, wherein the first target value for a braking torque is increased during the redistribution phase to a sum of the first target value and the second target value at the start of the redistribution phase and the second target value for a braking torque is reduced to zero.

3. The method of claim 2, wherein the first threshold value (v₀) for a vehicle speed is determined from an amount of time (tRamp) needed to increase the first target value for a braking torque to a sum of the first target value and the second target value at the start of the redistribution phase and reduce the second target value for a braking torque to zero.

4. A The method according to claim 1, wherein the first threshold value (v₀) for a vehicle speed is determined from a current deceleration of the vehicle (10).

5. The method of claim 1, wherein the first threshold value (v₀) for a vehicle speed is determined from the second threshold value (v₁) for a vehicle speed.

6. The method of claim 3, wherein the first threshold value (v₀) for a vehicle speed is determined as the sum of the second threshold value (v₁) for a vehicle speed and a product of the current deceleration (a) of the vehicle (10) and the time period (tRamp), that is needed to increase the first target value for a braking torque to a sum of the first target value and the second target value at the start of the redistribution phase, and reduce the second braking torque target value to zero.

7. A computing unit (12) configured to perform all method steps of a method according to claim 1.

8. (canceled)

9. A non-transitory computer-readable containing instructions that when executed by a computer cause the computer to control braking of a vehicle (10) having a first (14) and a second (16) electric drive motor, by in a first braking phase, specifying a first target value for a braking torque for the first electric drive motor (14), and specifying a second target value for a braking torque for the second electric drive motor (16),
sensing a current speed of the vehicle (10) as the actual speed,
when the actual speed reaches a first threshold value (v₀) for a vehicle speed, increasing the first target value for a braking torque in a redistribution phase and simultaneously reducing the second target value for a braking torque,
wherein, when the actual speed reaches a second threshold value (v₁) for a vehicle speed, the specification of the first target value for a braking torque is ended and a speed target trajectory (202) is specified in a second braking phase,
wherein the speed target trajectory proceeds from the second threshold value (v₁) for the vehicle speed to a speed of zero.
